(19) United States
(12) Patent Application Publication
(10) Pub. No.: US 2019/0220828 A1
(43) Pub. Date: Jul. 18, 2019

(54) METHODS AND SYSTEMS FOR RE-CONFIGURING A SCHEDULE OF A PREVENTIVE MAINTENANCE PLAN

(71) Applicant: salesforce.com, inc., San Francisco, CA (US)

(72) Inventors: KAVYA MURALI, FOSTER CITY, CA (US); RASIK PHALAK, FREMONT, CA (US); TYLER SHOPSHIRE, BERKELEY, CA (US); ARAVIND VENKATACHALAM, FREMONT, CA (US); XIAOYU XIE, REDWOOD CITY, CA (US); SINDHUBALA ULAVAPALLI, FREMONT, CA (US); KAUSHIK BHOWMIK, SAN FRANCISCO, CA (US); NEERAJ AHUJA, FREMONT, CA (US); JOJU ERUPPANAL, BELLEVUE, WA (US)

(73) Assignee: salesforce.com, inc., San Francisco, CA (US)

(21) Appl. No.: 15/873,690

(22) Filed: Jan. 17, 2018

(51) Int. Cl. G06Q 10/00; G06Q 10/06; G06F 15/18

(52) U.S. Cl. CPC G06Q 10/20; G06F 15/18; G06Q 10/063116

(57) ABSTRACT

A method and system for re-configuring a schedule for maintenance of an asset by use of a software product, which includes: defining, at a server, an asset object for receiving usage data of the asset wherein the usage data is generated by sensing devices associated with activities of the asset; configuring, at the server, a task relating to maintenance of the asset based on a pre-configured schedule, wherein the task is dependent on the usage data; receiving the usage data at the server for storing in the asset object; and analyzing, at the server, the usage data stored in the asset object for determining applicability of the task or changes in the task for re-configuring the pre-configured schedule.

### TECHNICAL FIELD

Embodiments of the subject matter described herein relate generally to scheduling tasks for a preventive maintenance plan in an Internet of Things (IoT) environment. More particularly, embodiments of the subject matter relate to methods and systems for re-configuring a schedule for the preventative maintenance service for an asset in an IoT environment.

### BACKGROUND

Vendors spend significant time and resources in putting together a preventive maintenance plan for servicing of assets used by customers to increase customer satisfaction and longevity of these assets. Vendors in general use a methodical and structured process for formulating the maintenance plan. Often, preventive maintenance plans are formulated using a top down methodology where maintenance plans are generated at the onset, prior to the sale of an article, where a maintenance plan is formulated and communicated to the customer with prescribed intervals of services and with each service an associated sets of tasks to be performed. For example, a maintenance plan for an automobile may be defined at the time the vendor produces the automobile. Further, all the automobiles of a particular type may be treated homogeneously and accorded a similar or the same preventive maintenance plan at the onset by the vendor based on projected or perceived usage of the automobile and therefore given defined service intervals using a top down framework without an actual understanding of the daily, weekly, monthly, or other usage of the particular automobile. One reason this occurs is because there are limited tools that are convenient and available for assessing asset usage in hindsight or in a bottom up methodology that allows for assessments of the set of tasks and scheduling of the tasks afforded to the particular asset.

Accordingly, it is desirable to use empirical data such as the usage data of a particular asset for the re-configuring of a pre-configured schedule of maintenance. In such instances, usage data may be stored in an associated software object and analyzed by various software applications of a server to determine tasks and changes of the tasks within a schedule of a tasks in the preventive maintenance plan in order to make plan modifications.

It is desirable to re-define or change tasks of the preventive maintenance plan based not on initial prescribed or configured tasks afforded each service appointment of the asset but on factors including: data of the daily usage of the asset to construct different models of tasks in scheduled services. For example, using the usage data to better identify current and future tasks and to change the tasks in the pre-configured preventive maintenance plan to create a re-configured schedule of tasks based on thresholds of usage data. The re-configuring of the tasks or sets of tasks may include excluding, changing, eliminating, merging together in the schedule of appointments of the plan, a particular task or set of tasks of the plan which form each of service appointments.

In other instances, it is desired to determine applicability of tasks to a service appointment and to determine changes of a task or set of tasks for further subsequent maintenance services that may occur because of notices from vendors or other parties about aspects of operation of an asset. For example, there may be necessary repairs causing interruptions of the asset usage which in turn may result in changes of the original task and service schedules for preventative maintenance.

Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is an exemplary diagram illustrating the preventative maintenance plan service in a preventative maintenance app system in accordance with an embodiment;

FIG. 2 is an exemplary diagram illustrating an asset client and server system for capturing data of asset use in the preventative maintenance service app system in accordance with an embodiment;

FIG. 3 is an exemplary diagram illustrating a record of an asset in the preventative maintenance service app system in accordance with an embodiment;

FIG. 4 is an exemplary block diagram illustrating configuring and re-configuring the preventative maintenance plan of the preventative maintenance service app system in accordance with an embodiment;

FIG. 5 is an exemplary flowchart illustrating user steps for configuring and re-configuring the preventative maintenance plan in the preventative maintenance service app system app system in accordance with an embodiment; and

FIG. 6 is a schematic block diagram of a multi-tenant computing environment for use in conjunction with the preventative maintenance service app system in accordance with an embodiment.

### DETAILED DESCRIPTION

Business preventive maintenance schedules and plans are of importance because such services can be highly profitable to vendors. Hence, customers when considering purchasing a particular asset have to take into account these added costs. Moreover, commercial as well as non-commercial use of assets can be complex and fuzzy, hence vendors are forced to make assumptions which result in preventive maintenance schedules of services that are often similarly constructed in rudimentary structured frameworks. As a result, this initial framework or plan often has to be changed when, for example, unexpected services are required. However, the structured framework often is modified on an ad-hoc basis while keeping the general structured framework in place. This may lead to inefficiencies, omissions of appropriate levels of services, omissions of proper documentation associated with the service calls and overall unclear preventive maintenance plan goals being communicated to the customer.

Hence, it is desirable to provide a methodology of a framework that allows for flexibility, monitors asset operations, allows for changeability as a result of unexpected incidents in asset operations and provides for a hosted system that communicates the changed plans to the customer.

Further, it is desirable to capture data for tasks performance to service assets identified in a maintenance plan by software applications to enable a bottom up approach of identification of various tasks and service appointments based on analysis of the captured data.

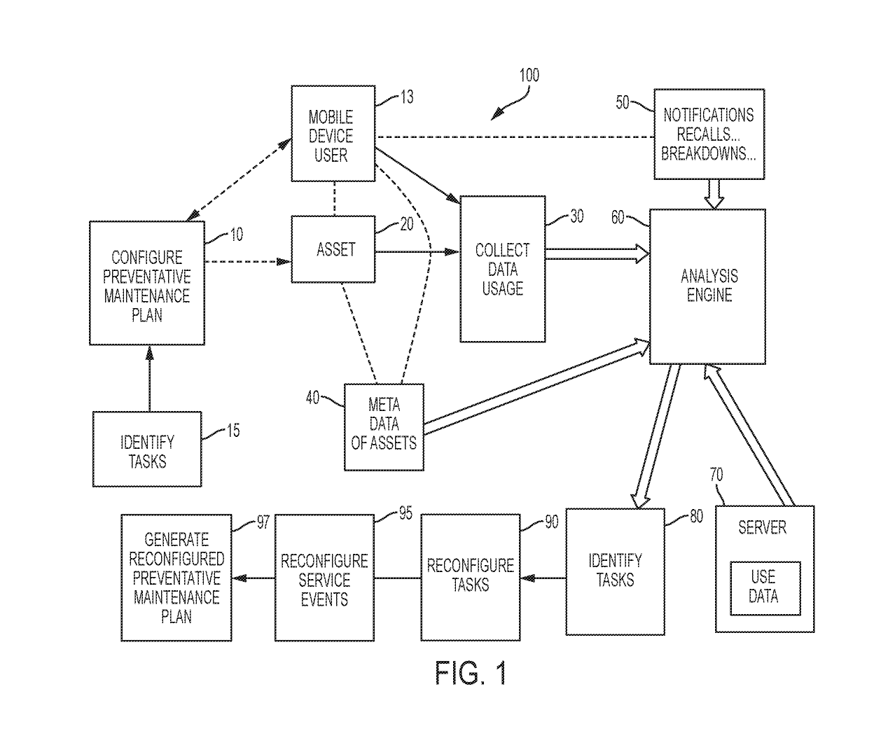

FIG. 1 is an exemplary diagram that illustrates a methodology for generating and receiving data in the preventative maintenance system in accordance with an embodiment. Briefly, as explained earlier, the preventative service app system gathers data associated with the particular asset, stores the data, and analyzes the data to re-configure a preventative maintenance schedule. The preventative maintenance app service system 100 includes a preventative maintenance plan 10 which is prepared in conjunction with assets identified by the vendor, and it includes a series of service tasks 15 for services of the preventative maintenance plan 10. That is, the assets are identified by the vendor so that a preventative maintenance plan 10 can be electronically associated with each asset.

In exemplary embodiments, the preventative maintenance plan 10 may be sent to a mobile device 13 associated with the asset 20 or may simply reside at the server. In addition, alerts may be triggered to provide notifications of upcoming service events.

In exemplary embodiments, the data may be generated by the following entities, without limitation: data sensed by various sensors associated with a particular asset, data identified by the use of the software app on a mobile device related to an operation of the particular asset, and data derived from metadata particularly generated in conjunction with operating an asset. While the use of sensors is one mode of generating data associated with the particular asset, other modes of data generation and other tools to generate the data that may be employed.

For example, the data may be derived as follows: by machine data from operations of the asset 20, by the user accessing the software app associated with the asset 20, and/or by an application which enables downloading templates and filling out various templates and uploading the templates for data collection by the system. Also, social media type apps may be accessed to supplement the data sets of usage. In other instances, prior histories of the asset or of related assets may be used to augment the current usage data set.

In the particular instance, the usage data sensed by sensor and the meta data related to the asset 20 is collected by a processing module 30 and sent for further processing to an analysis engine 60. The analysis engine may reside in the cloud or at a server and may be part of the local ecosystem or part of the vendor's ecosystem. Further, the analysis engine 60 may have accessibility to further information 50 of the vendor or customer at remote databases and may utilize a flexible data structure or tabular structure that allows for transcoding of heterogenous data types for inclusion in the data set and further analysis. In addition, the software app may reside in part or in whole at a server 70 that may reside on a different server platform than the analysis engine 60. For example, the analysis engine 60 may reside on a third-party server with a completely different platform from the software app 75 residing on the server 70. The analysis engine 60 may use various algorithmic solutions, more specifically algorithms relating to clustering to identify tasks 80. Once the tasks 80 are identified in view of the data processed, the reconfiguring of the tasks as reconfigured tasks sets 90 may be prescribed to a re-configured set of preventative maintenance events 95. A set of preventative maintenance events that were previously defined based on the vendor forecasted usage, time and other attributes of the particular asset 20 at the onset of the asset operation in a top down modeling, as a result of the clustering and identified tasks now associated with events in the preventative maintenance plan may now be redefined by the identified tasks and events.

In general, when identifying and categorizing tasks and events in the preventative maintenance plan in an efficient manner there are subjective decisions that must be made. Therefore, a plethora of data related to asset activities or user behavior when operating or using the asset including an individual's and asset daily types of activities and times spent on such daily activities is required for accuracy. To effectively craft a dynamic preventative maintenance plan, a large volume of data is generated that addresses both in-app usage and real-life routines of assets for identifying data sets of commonalities and a corresponding number of attributes for the particular asset. That is, once the core user and asset behaviors by large data sets are identified using various grouping or clustering solutions, these core asset and user behaviors may be crafted bottom up by the data clustering in a manner to match or substantially match a particular set of tasks 90, reconfigure the maintenance events 95 and reconfigure the preventative maintenance plan 97.

In addition, users associated with assets may be formulated and using persona type modeling. In fact, data sets derived in the bottom up formulations of a particular asset usage and user use may lend themselves to persona attributes, result in different personas or different sets of persona.

In accordance with a typical implementation, the data may include parts or segments for representing an asset's daily routines of objectives, problems, orientation, obstacles, preferences, and engagement scenarios. In an exemplary embodiment, the business pipe-line may also undergo changes resulting in different identified tasks 80 for the preventative maintenance of each asset; the data collected will reflect the changes, and the data is directly attributable to the tasks of the business pipeline.

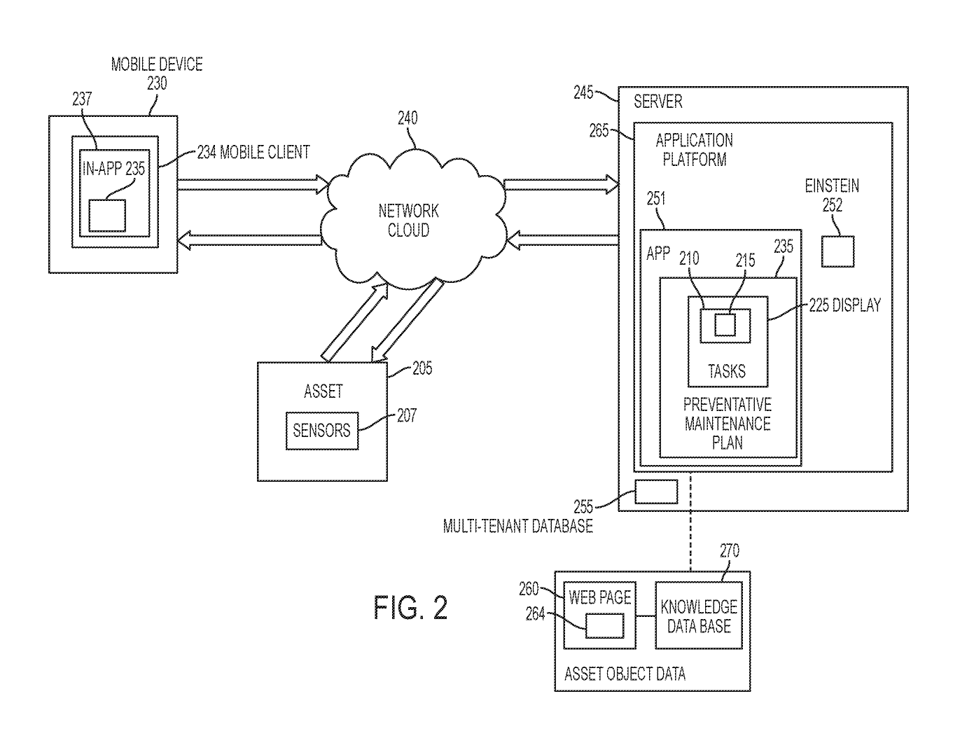

FIG. 2 depicts an exemplary embodiment of the preventative maintenance app system. The preventative maintenance plan via the app 235 may be configured to reside on the server 245 using a multitude of user-interface displays 225 to display the usage data 215 and the tasks 210 in a server application 251. In alternate embodiments, the preventative maintenance plan via the app 235 may reside elsewhere in the network. The preventative maintenance plan via the app 235 is accessible to a set of subscribers or users of the asset 205 via the app 235 hosted by a mobile device 230. The preventative maintenance plan via the app 235 may include a set of tasks 210. The tasks 210 can be considered a manner of extracting and identifying usage data 215 related to the following, without limitation: use of the software app, tasks performed by the asset 205, user behavior of the user operating the asset 205, and sensor data from one or more sensors 207 of the asset 205 etc. The tasks identified allows for an increase in the understanding of how the asset 205 and user see the asset related activities that may be beyond, in instances, the usage logs, the bug reports filed, or the features requested. In other words, the tasks 210 give a more complete understanding of the asset usage in everyday real-life scenarios that mimic daily asset routines.

In an exemplary embodiment, a user may be asked a series of questions to answer via a survey or other instruments. In the instance of asking user questions, the questions may be in the form of hypotheticals, analogies, or real world examples, and may be asked directly or indirectly with respect to the asset operations. As such, the questions associated with the preventative maintenance plan via the app 235 include a significant number of possibilities but are reduced based on history and prior feedback. In addition, machine learning and artificial intelligence applications may be employed to search remote databases, identify patterns and model data sets in attempts to augment data derived from the sets of questions and asset activities.

As an example, a user would view a set of questions of tasks 210 of the asset 205 operation on the mobile display 237 of the mobile device 230 during a session. The user may be given immediate feedback after completion of the session and this data may be included in preventative maintenance plan via the app 235 via the mobile device 230. Such feedback may include insights into the asset operational behavior or tasks performed, and may also include feedback in relation to other users and assets having similar roles to show differences to the asset usage. In certain instances, the user may desire to make changes to the tasks 210 and the app 235 may be configured to allow for changes, or may allow for options of changes for the user. While the preventative maintenance plan via the app 235 receives input by the user and usage data 215 from the asset itself, other means of input to the preventative maintenance plan via the app 235 may also be used. For example, third party data of notices and well as user conversations using natural language processing solutions may be used in conjunction with the app 235 of the mobile client 234. After asset usage data is entered, the usage data from the asset 205 is uplinked or streamed via a network cloud to a server 245 store in a data set as the usage data 215 for analysis.

With a continued reference to FIG. 2, a cloud based network system or platform may be used where the mobile device 230 and asset 205 are communicating via a network cloud 240 to a server 245. In instances, an app hosted on an app platform of the server 245 may be configured in the platform to operate on-demand to communicate between the network cloud 240 and the mobile device 230. The network cloud 240 may include interconnected networks including both wired and wireless networks for enabling communications of the mobile device 230 via a mobile client 234 to the server application 251 hosted by server 245. For example, wireless networks may use a cellular-based communication infrastructure that includes cellular protocols such as code division multiple access (CDMA), time division multiple access (TDMA), global system for mobile communication (GSM), general packet radio service (GPRS), wide band code division multiple access (WCDMA) and similar others. Additionally, wired networks include communication channels such as the IEEE 802.11 standard better known as Wi-Fi®, the IEEE 802.16 standard better known as WiMAX®, and the IEEE 802.15.1 better known as BLUETOOTH®. The network cloud 240 allows access to communication protocols and application programming interfaces that enable real-time video streaming and capture at remote servers over connections

The mobile device 230 includes the mobile client 234 which may use a mobile software development kit “SDK” platform. This SDK platform can provide one step activation of an on-demand services via the app 235 such as shown here of the mobile client 234 for activating the on-demand service such as the preventative maintenance service app of the present disclosure. The mobile device 230 may include any mobile or connected computing device including “wearable mobile devices” having an operating system capable of running mobile apps individually or in conjunction with other mobile or connected devices. Examples of “wearable mobile devices” include GOOGLE® GLASS™ and ANDROID® watches. Typically, the device will have capabilities such as a display screen, a microphone, speakers and may have associated keyboard functionalities or even a touchscreen providing a virtual keyboard as well as buttons or icons on a display screen. Many such devices can connect to the internet and interconnect with other devices via Wi-Fi, Bluetooth or other near field communication (NFC) protocols.

The mobile client 234 may additionally include other apps 235 as well as SDK app platform tools and further can be configurable to enable downloading and updating of the SDK app platform tools. In addition, the mobile client 234 uses an SDK platform which may be configurable for a multitude of mobile operating systems including ANDROID®, APPLE® iOS, GOOGLE® ANDROID®, Research in Motion's BLACKBERRY OS, NOKIA's SYMBIAN, HEWLET_PACKARD®'s WEBOS (formerly PALM® OS) and MICROSOFT®'s WINDOWS Phone OS

The app 235 of the mobile client 234 may be provided on an SDK platform and can be found and downloaded by communicating with an on-line application market platform for apps which is configured for the identifying, downloading and distribution of prebuilt apps. One such example is the SALESFORCE APPEXCHANGE® which is an online application market platform for apps where the downloading, and installing of the pre-built apps and components such as an app 235 for the mobile client 234 with preventative maintenance service app features.

In addition, these on-line application market platforms include “snap-in” agents for incorporation in the prebuilt apps that are made available. The app 235 may be configured as a “snap-in” agent where the snap-in agent is considered by the name to be a complete SDK packages that allows for “easy to drop” enablement in the mobile client 234 or into webpages.

The server 245 acts as a host and includes the server application 251 that is configured for access by an application platform 265. The application platform 265 can be configured as a platform as a service (“PaaS) that provides a host of features to develop, test, deploy, host and maintain-applications in the same integrated development environment of the application platform. Additionally, the application platform 265 may be part of a multi-tenant architecture where multiple concurrent users utilize the same development applications installed on the application platform 265. Also, by utilizing the multi-tenant architecture in conjunction with the application platform 265 integration with web services and databases via common standards and communication tools can be configured. As an example, SALESFORCE SERVICECLOUD® is an application platform residing on the server 245 that hosts the server application 251 and may host all the varying services needed to fulfil the application development process of the server application 251. The SALESFORCE SERVICECLOUD®, as an example, may provide web based user interface creation tools to help to create, modify, test and deploy different UI scenarios of the server application 251.

The application platform 265 includes applications relating to the server application 251. The server application 251 is an application that communicates with the mobile client 234, and may provide enhanced data communications to the mobile client 234 such as multimedia data capture. The server application 251 may include other applications in communication and data discovery for accessing a multi-tenant database 255 as an example, in a multi-tenant database system. In addition, the server application 251 may include components configurable to include user-interfaces (UI) to display a webpage 260 created or potentially alternative webpage configurations for selection and viewing. In an exemplary embodiment, the display of data on the webpage 260 may configured by various configurations of the UIs. The SALESFORCE SERVICECLOUD® platform is an application platform 265 that can host applications for creating webpages of UIs for communication with an app 235 of the mobile client 234.

With continuing reference to FIG. 2, the display of the webpage 260 includes object data 264 which may include results of data sets displayed by different configurations of components formed by UIs showing the data. Additionally, the application platform 265 has access to other databases for information retrieval which may include a knowledge database 270 that has artificial intelligence functionality 252. In an exemplary embodiment, the SALESFORCE® EINSTEIN™ data discovery app may include data discovery functionality that can be used with data from a SALESFORCE® app for collecting additional types of data and can allow for training of deep learning models to recognize and classify data sets of the usage data 215 received.

In addition, the user can search for the answers using the knowledge database 270 which may be part of the multi-tenant database architecture allowing for communication with the mobile client 234. The knowledge database 270 may include an object data repository configured to allow the user to browse for information relating to the assets and enabling sending that information to the webpage 260. In addition, the application platform 265 can access a multi-tenant database 255 which may be part of the multi-tenant architecture. The multi-tenant database 255 allows the enterprise customer access to the multi-tenant database 255, and in turn the application platform 265 may be given access to the multi-tenant database by enterprise customer users. In instances, this access may be dependent upon differing factors such as a session ID associated with the preventative maintenance service app session.

With a continued reference to FIG. 2, the mobile device 230 may include representations of the preventative maintenance service plan via the app 235 which may also include a “snap-in” agent with an UI configured for initiating or terminating a preventative maintenance app's execution or other functional settings when the app 235 is executing varies steps of the preventative maintenance service plan via the app 235 and tasks 210. Additionally, the preventative maintenance service plan via the app 235 can be configured to reside in part or be presented in part on other interconnected devices. An example of this multi-device hosting would be interconnections of smart phones coupled with wearable devices where the display may be found on an interconnected device or both the mobile and interconnected device.

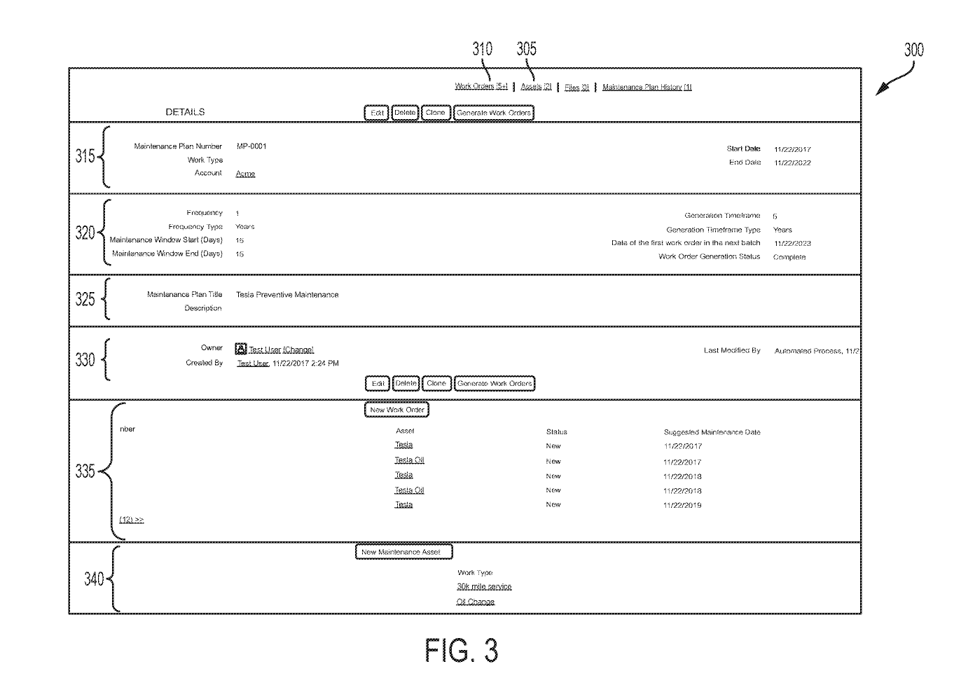

With a reference to FIG. 3, FIG. 3 is an exemplary diagram illustrating a screen shot of a record for data collection in the preventative maintenance service app system in accordance with an embodiment. In an exemplary embodiment, the record 300 of an asset may include sections as follows: tab buttons that navigate to work orders 310, assets 305, files 307 and maintenance plan histories 309 generated by user actions. In section 315 an exemplary embodiment of fields for identifying the following information: the maintenance plan number, work type and account. In addition, the start and end dates for a maintenance plan are shown. In 320, in an exemplary embodiment of a work order illustrated, the work order includes: the frequency of the work order, the frequency type, the maintenance window start and end dates, and the data related to: timeframes, types of time frames, data of the first work order and the status of the work order. In 325, the maintenance plan is given a plan title to which a description may be added. In 350, the user or owner is identified and associated with the asset; and various editing functions are added to generate, edit, delete, clone or perform other functions on the work order. In 335, a listing of work orders associated with an asset is shown. In the work orders, the fields are identified for populating and include the fields of the asset type, the status of the work order of the asset, and the suggested date of a service maintenance.

Finally, in 340, additional or new maintenance services can be added along with the work type associated with the new maintenance service. The record 300 may be stored at the server or cloud and may be associated with multiple types of software apps including a software-as-a-service (SaaS) app, a cloud app, a server hosted app, and/or a combination of a client, a cloud and a server hosted app in which the app can be used by users from a multitude of locations as well as be able to be accessed by different devices. The maintenance plan items are subjective in nature and constructed by empirical testing. The record 300 itself may be editable and re-configurable depending on the record data required for processing of tasks and service appointments or related events, and further the data of the record may be sent to an analysis engine (not shown) for various analysis and for the rendering in easy to illustrate graphs and tables of the tasks performed, service events and other attributes of the preventative maintenance plan.

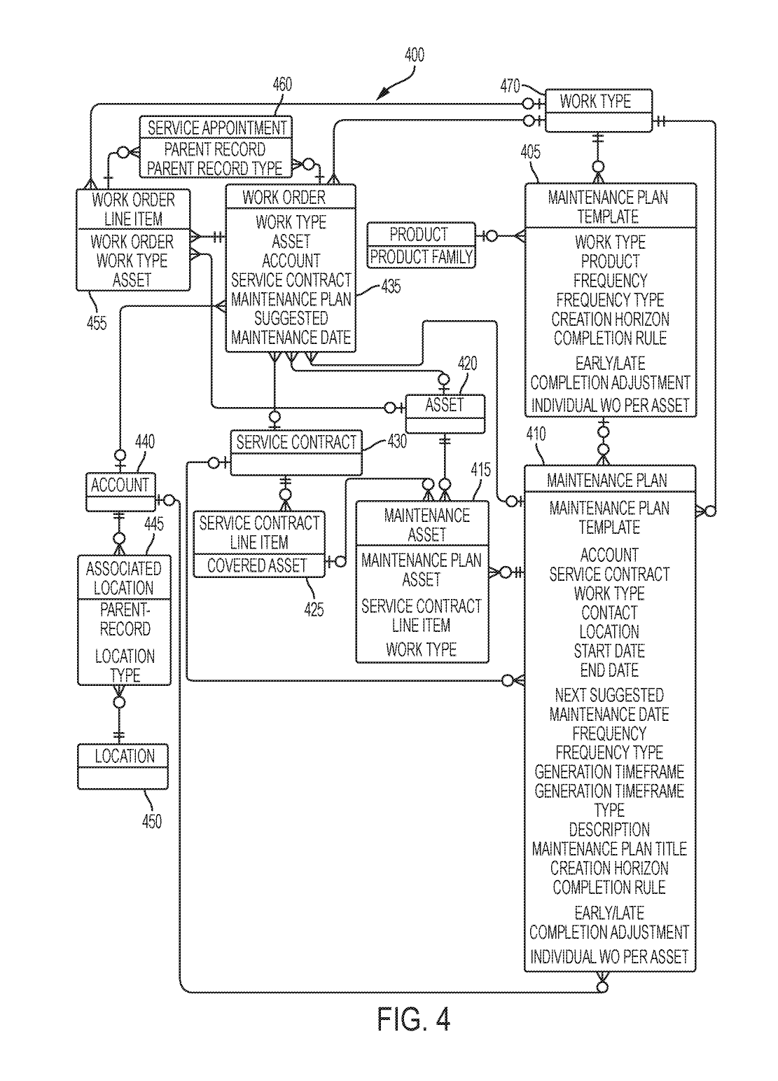

With a reference to FIG. 4, FIG. 4 is an exemplary diagram illustrating business process steps in the preventative maintenance app system in accordance with an embodiment. In an exemplary embodiment, the preventative maintenance service app system 400 includes a module to configure the preventive maintenance plan at 410. A master template module at 405 may be used to allow a user to configure a base or master template for forming a maintenance plan and the maintenance plan template may include the items of work type, product, frequency, frequency type, creation horizon, completion rule, early/late completion adjustment, and individual work order per asset. In a next step, the user may configure a number of attributes associated with the maintenance plan for an individual asset. For example, in an exemplary embodiment as illustrated at 410, the module may include use of a maintenance plan template for further configuring in accordance with a user or vendors a desired set of attributes for tasks on which service events are built for the maintenance plan. For example, as shown at 410, the module to perform this configuration may include the features of a maintenance plan template, an account, a service contract, a location, a start date and an end date, a time for the suggesting the next maintenance service, a frequency, a frequency type, a generation time frame and a generation timeframe type, a maintenance plan title, a creation horizon, a completion rule, an early/late completion adjustment, and an individual work order (WO) per asset. The module for generating the maintenance plan at 410 is coupled to a maintenance asset module at 415. The maintenance asset module at 415 may be configured to include information such as: information about the maintenance plan itself for the asset, information of the service contract line items, and information of the work type. The maintenance asset module at 415 is coupled to the asset module at 420 and the service contract line item at 425 which includes the covered asset. The service contract module at 430 is coupled to the maintenance plan at 410 and is a component of the maintenance plan laying out the terms of the service to the user. The work order module at 435 feeds into the following entities during the configuration process: the service contract at 430, the asset at 420 and the maintenance plan at 410. The work order module at 435 defines the work order which may be composed of or configured of the entities as follows: work type, asset, account, service contract, maintenance plan, and a suggested maintenance date. The service appointment module at 460 may be constructed in the following manner: the parent record and the parent record type sends information to the work order 435 for associating with the work order. The work order line item module at 455 then may generate line items of the work orders, the work type and the assets of the work order. This information may be also received by the work type module at 470. The work type module at 470 is then associated with the asset at 420. At 440, an account module 440 is then configured in the maintenance plan at 410 and may include at 445 an associated location module. The associated location module at 445 includes the items of: a parent/record, a location, and a type and these items may be associated with the location module at 450.

The initial preventative maintenance service plan is configured at 410 with the help of the maintenance plan template at 405. When work orders are generated at the work order module at 435 the work order information is sent to the maintenance plan at 410 to update or re-configure the maintenance plan. In other words, the pre-configured maintenance plan at 410 is re-configured or amended with the new information from the work orders. The new information may include rules, conditions or process information from the analytics engine. This feedback process which is an iterative integrated process allows an user to manipulate the items of the maintenance plan at 410 by changing the item data. For example, the user may use the maintenance plan template at 405 to assist in making the changes to the item data. In addition, the work orders are limited the constraints of the service contract at 420 which may include the service contract line items at 425. This filtering is illustrated at 415 where the maintenance plan of the asset is tied to the service contract line item which includes the maintenance plan asset and the work type. Hence the service contract line items are inclusive of the items in the maintenance plan so as to prevent maintenance items that are not part of the service contract. In addition, this feature may also include limitations placed on the work types.

Further, the items of the service contract at 430 may be used to construct or pre-configure the maintenance plan. If additional service items are added in the preventative maintenance plan, then it should be understood there must be support or representation in the service contract that the user can add the additional items. If in the service contract, the items are not included or there is no provisions for including additional items, then the items will generally not be included in the original maintenance plan unless the user is given sufficient authority to make such additions. In various other embodiments, the preventative maintenance service app system, provides software tools at 405 or at 410 to merge in, exclude, render not applicable or add in items that are not part of the original service contract.

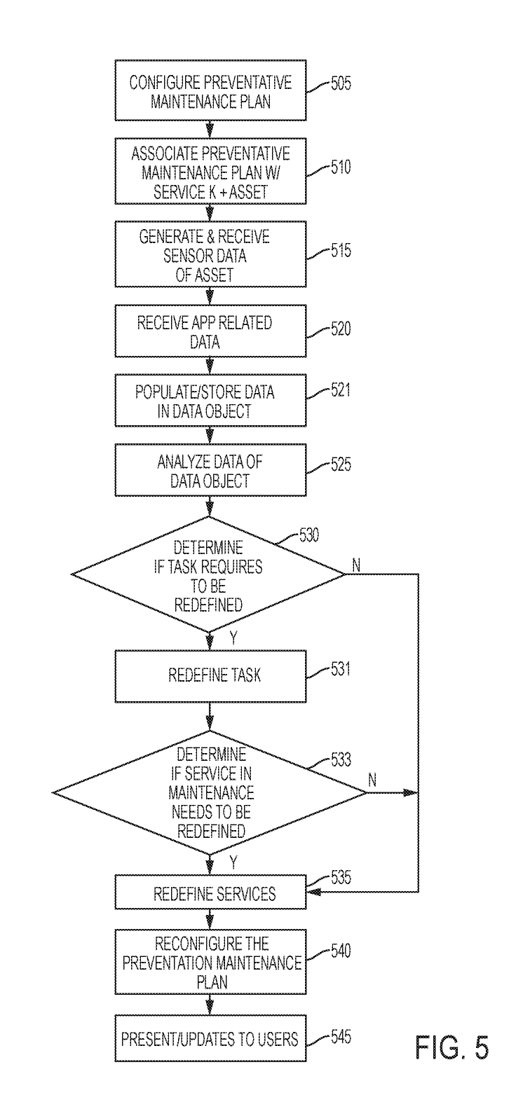

FIG. 5 is an exemplary flowchart of a method illustrating user steps for configuring a preventative maintenance plan and for re-configuring the preventative maintenance plan based on asset usage data as well as a particular service contract. More particularly, the exemplary method 500 includes the step of configuring the preventative maintenance plan by the vendor or the user. At step 510, the particular preventative maintenance plan is associated with an asset and a service contract. The service contract provides the terms of the service tasks and service appointments in the preventative maintenance plan for a particular asset. At step 515 sensing data is received about a particular asset and that data is combined with data received from the user via a mobile device or app at step 520. At step 521, the usage data is stored in data sets in an object associated with the asset. In exemplary embodiments, the data may be locally stored or may be stored at the server. Additionally, the data may be stored in a hybrid arrangement as the usage data is generated by populating an object in an intermittent manner or uploading to the server in an intermittent manner to lessen processing overhead locally and at the server. The data is analyzed by an analytics engine (not shown) at step 525 using various solutions or rules associated with the service contract and maintenance plan to identify, construct, determine if applicable or not particular tasks and sets of configurations of tasks and service appointment events in a schedule based on the usage data. Additionally, this analysis is not limited to the usage data and may include other related usage data and unrelated data of usage for the particular asset. For example, there may be notices of recalls that requiring service appointments or these recall service appointments may be included with various service appointments of tasks already scheduled in the preventative maintenance service plan.

In various exemplary examples, as a result of recalls, breakdowns, unexpected service interruptions etc., a preventative maintenance service plan may need to be re-configured for a particular service appointment or task changed, eliminated, render no longer applicable to account for the changes. For example, a task related to the recall may now include additional steps in a work order to respond to the recall. At step 530, a determination is made as to whether a task needs to be re-defined or changed based on the usage data and other factors. In instances, the determination made be made by sets of rules configured in the maintenance plan or an analysis of the usage data. If a task does not need to be re-defined or eliminated, then it is likely that material changes in the present configuration of the maintenance plan are not needed; and the flow skips to the service re-configuration step at 533. Alternately, at 531 if the tasks is no longer applicable or needs to be changed, that is the tasks in the original or configured preventative maintenance service plan schedule incur changes necessitating a task to be re-defined, eliminated, skipped, added or determined no longer applicable to account for the needed changes. Once the changes are made with the tasks, then at 533, a determination is made if services built on the tasks in the maintenance plan need to changed. Again, in instances, another set of rules may be devised or analysis of the usage data performed to make or assist in making the determination of changes in tasks and schedule of the service appointment. If changes are needed in the service appointment then, at step 535, along with changes in the tasks, the service appointments made up of tasks in the work order may also be changed. For example, these changes may include: amendments in the time between service appointments to amend the time by shortening or increasing intervals between service appointments. In instances, this re-configuring of the intervals or schedules of service appointments may be due to usage of the particular asset, recall notices related to the particular asset etc. Also, a tasks for a particular service may now be included in earlier or later service appointments or may simply be eliminated as a result of the re-configuration of the preventative maintenance service plan. At step 540, the preventative maintenance service plan is re-configured in view of the redefined service appointments and tasks. At step 545, the updates to the re-configured preventative maintenance service plan are presented to the user. In an exemplary embodiment, the updates may be presented in the form of mobile alerts to the user; alerting the user of a change in the preventative maintenance service plan.

In an exemplary embodiment, the SALESFORCE EINSTEIN™ application may communicate with user to provide related data at step 540 using artificial intelligence and machine language techniques to analyze the usage data of the asset received and found in the data object associated with the preventative maintenance service app.

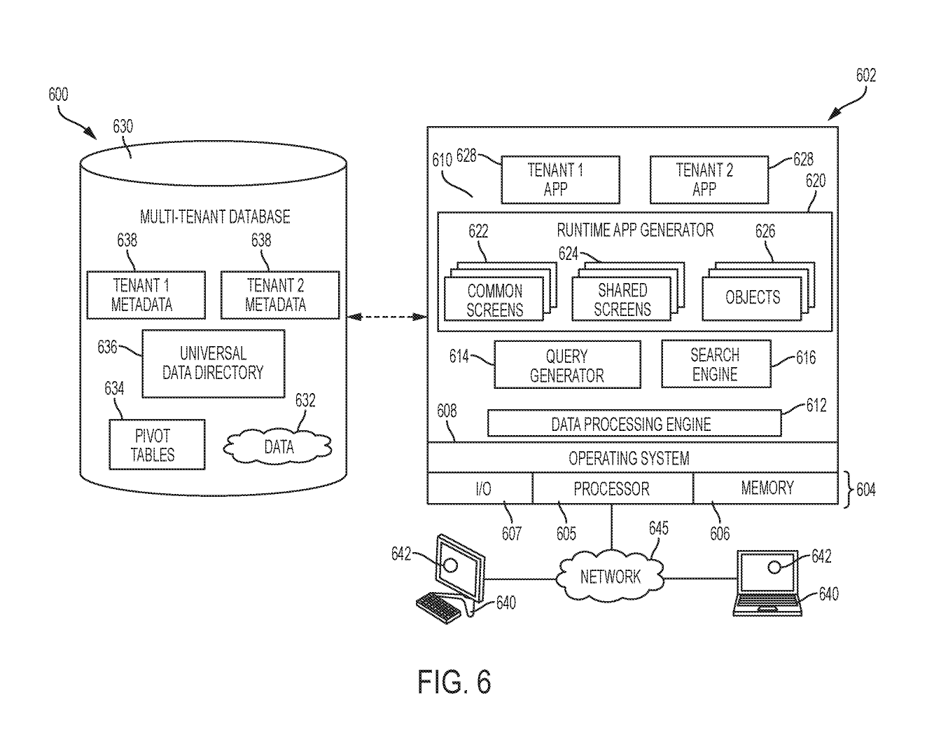

With a reference to FIG. 6, FIG. 6 is a schematic block diagram of a multi-tenant computing environment for use in conjunction with preventative maintenance service app system in accordance with an embodiment. A server may be shared between multiple tenants, organizations, or enterprises, referred to herein as a multi-tenant database. In the exemplary disclosure, software app services are provided via a network 645 to any number of tenant devices 640, such as desk tops, laptops, tablets, smartphones, Google Glass™, and any other computing device implemented in an automobile, aircraft, television, or other business or consumer electronic device or system, including web tenants.

Each application 628 is suitably generated at run-time (or on-demand) using a common type of application platform 610 that securely provides access to the data 632 in the multi-tenant database 630 for each of the various tenant organizations subscribing to the service cloud 600. In accordance with one non-limiting example, the service cloud 600 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 630. In this regard, each tenant includes one or more users and/or groups associated with, authorized by, or otherwise belonging to that respective tenant. Stated another way, each respective user within the multi-tenant system of the service cloud 600 is associated with, assigned to, or otherwise belongs to a particular one of the plurality of enterprises supported by the system of the service cloud 600.

Each enterprise tenant may represent a company, corporate department, business or legal organization, and/or any other entities that maintain data for particular sets of users (such as their respective employees or customers) within the multi-tenant system of the service cloud 600. Although multiple tenants may share access to the server 602 and the multi-tenant database 630, the particular data and services provided from the server 602 to each tenant can be securely isolated from those provided to other tenants. The multi-tenant architecture therefore allows different sets of users to share functionality and hardware resources without necessarily sharing any of the data 632 belonging to or otherwise associated with other organizations.

The multi-tenant database 630 may be a repository or other data storage system capable of storing and managing the data 632 associated with any number of tenant organizations. The multi-tenant database 630 may be implemented using conventional database server hardware. In various embodiments, the multi-tenant database 630 shares the processing hardware 604 with the server 602. In other embodiments, the multi-tenant database 630 is implemented using separate physical and/or virtual database server hardware that communicates with the server 602 to perform the various functions described herein.

In an exemplary embodiment, the multi-tenant database 630 includes a database management system or other equivalent software capable of determining an optimal query plan for retrieving and providing a particular subset of the data 632 to an instance of application (or virtual application) 628 in response to a query initiated or otherwise provided by an application 628, as described in greater detail below. The multi-tenant database 630 may alternatively be referred to herein as an on-demand database, in that the multi-tenant database 630 provides (or is available to provide) data at run-time to on-demand virtual applications 628 generated by the application platform 610, as described in greater detail below.

In practice, the data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired. Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants.

Tenant-specific formatting, functions and other constructs may be maintained as tenant-specific metadata 638 for each tenant, as desired. Rather than forcing the data 632 into an inflexible global structure that is common to all tenants and applications, the multi-tenant database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data from the multi-tenant database 630.

The server 602 may be implemented using one or more actual and/or virtual computing systems that collectively provide the dynamic type of application platform 610 for generating the virtual applications 628. For example, the server 602 may be implemented using a cluster of actual and/or virtual servers operating in conjunction with each other, typically in association with conventional network communications, cluster management, load balancing and other features as appropriate. The server 602 operates with any sort of processing hardware 604 which is conventional, such as a processor 605, memory 606, input/output features 607 and the like. The input/output features 607 generally represent the interface(s) to networks (e.g., to the network 645, or any other local area, wide area or other network), mass storage, display devices, data entry devices and/or the like.

The processor 605 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 606 represents any non-transitory short or long term storage or other computer-readable media capable of storing programming instructions for execution on the processor 605, including any sort of random access memory (RAM), read only memory (ROM), flash memory, magnetic or optical mass storage, and/or the like. The computer-executable programming instructions, when read and executed by the server 602 and/or processors 605, cause the server 602 and/or processors 605 to create, generate, or otherwise facilitate the application platform 610 and/or virtual applications 628 and perform one or more additional tasks, operations, functions, and/or processes described herein. It should be noted that the memory 606 represents one suitable implementation of such computer-readable media, and alternatively or additionally, the server 602 could receive and cooperate with external computer-readable media that is realized as a portable or mobile component or platform, e.g., a portable hard drive, a USB flash drive, an optical disc, or the like.

The application platform 610 is any sort of software application or other data processing engine that generates the virtual applications 628 that provide data and/or services to the tenant devices 640. In a typical embodiment, the application platform 610 gains access to processing resources, communications interface and other features of the processing hardware 604 using any sort of conventional or proprietary operating system 608. The virtual applications 628 are typically generated at run-time in response to input received from the tenant devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the tenant devices 640. The virtual applications 628 are typically constructed in accordance with the tenant-specific metadata 638, which describes the particular tables, reports, interfaces and/or other features of the particular application 628. In various embodiments, each virtual application 628 generates dynamic web content that can be served to a browser or other tenant program 642 associated with its tenant device 640, as appropriate.

The runtime application generator 620 suitably interacts with the query generator 614 to efficiently obtain data 632 from the multi-tenant database 630 as needed in response to input queries initiated or otherwise provided by users of the tenant devices 640. In a typical embodiment, the query generator 614 considers the identity of the user requesting a particular function (along with the user's associated tenant), and then builds and executes queries to the multi-tenant database 630 using system-wide metadata 636, tenant specific metadata, pivot tables 634, and/or any other available resources. The query generator 614 in this example therefore maintains security of the common database by ensuring that queries are consistent with access privileges granted to the user and/or tenant that initiated the request.

With continued reference to FIG. 6, the bulk data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc.

In exemplary embodiments, the application platform 610 is utilized to create and/or generate data-driven virtual applications 628 for the tenants that they support. Such virtual applications 628 may make use of interface features such as custom (or tenant-specific) screens 624, standard (or universal) screens 622 or the like. Any number of custom and/or standard objects 626 may also be available for integration into tenant-developed virtual applications 628. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 632 associated with each virtual application 628 is provided to the multi-tenant database 630, as appropriate, and stored until it is requested or is otherwise needed, along with the metadata 638 that describes the particular features (e.g., reports, tables, functions, objects, fields, formulas, code, etc.) of that particular virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the multi-tenant database 630. In this regard, the object type defines the structure (e.g., the formatting, functions and other constructs) of each respective object 626 and the various fields associated therewith.

Still referring to FIG. 6, the data and services provided by the server 602 can be retrieved using any sort of personal computer, mobile telephone, tablet or other network-enabled tenant device 640 on the network 645. In an exemplary embodiment, the tenant device 640 includes a display device, such as a monitor, screen, or another conventional electronic display capable of graphically presenting data and/or information retrieved from the multi-tenant database 630, as described in greater detail below.

Typically, the user operates a conventional browser application or other tenant program 642 executed by the tenant device 640 to contact the server 602 via the network 645 using a networking protocol, such as the hypertext transport protocol (HTTP) or the like. The user typically authenticates his or her identity to the server 602 to obtain a session identifier (“Session ID”) that identifies the user in subsequent communications with the server 602. When the identified user requests access to a virtual application 628, the runtime application generator 620 suitably creates the application at run time based upon the metadata 638, as appropriate. However, if a user chooses to manually upload an updated file (through either the web based user interface or through an API), it will also be shared automatically with all of the users/devices that are designated for sharing.

As noted above, the virtual application 628 may contain Java, ActiveX, or other content that can be presented using conventional tenant software running on the tenant device 640; other embodiments may simply provide dynamic web or other content that can be presented and viewed by the user, as desired. As described in greater detail below, the query generator 614 suitably obtains the requested subsets of data 632 from the multi-tenant database 630 as needed to populate the tables, reports or other features of a particular virtual application 628. In various embodiments, application 628 embodies the functionality of an interactive performance review template linked to a database of performance metrics, as described below in a connection with FIGS. 1-6.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 6 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with viewing, object identification, sharing and information retrieving processes between the mobile client and agent in video-chat applications may be performed by software, hardware, firmware, or any combination thereof. For illustrative purposes, the following description of data usage, assets, tasks, services appointments and processes may refer to elements mentioned above in connection with FIGS. 1-6. In practice, portions of process of FIGS. 1-6 may be performed by different elements of the described system, e.g., mobile clients, server, cloud, in-app applications etc.

It should be appreciated that process of FIGS. 1-6 may include any number of additional or alternative tasks, the tasks shown in FIGS. 1-6 need not be performed in the illustrated order, and process of the FIGS. 1-6 may be incorporated into a more comprehensive procedure or process having additional functionality not described in detail herein. Moreover, one or more of the tasks shown in FIGS. 1-6 could be omitted from an embodiment of the process shown in FIGS. 1-6 as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for re-configuring a schedule for maintenance of an asset by use of a software product, the method comprising:
defining, at a server, an asset object for receiving usage data of the asset wherein the usage data is generated by sensing devices associated with activities of the asset;
configuring, at the server, a task relating to maintenance of the asset based on a pre-configured schedule, wherein the task is dependent on the usage data;
receiving the usage data at the server for storing in the asset object; and
analyzing, at the server, the usage data stored in the asset object for determining applicability of the task or changes in the task for re-configuring the pre-configured schedule.

2. A method of claim 1, further comprising:
analyzing, at the server, the usage data by applying a set of rules to determine whether the task of the pre-configured schedule is still applicable, or alternately has incurred a change.

3. The method of claim 2, further comprising:
amending, at the server, the pre-configured schedule if the task is deemed not applicable, or a change has incurred in the task necessitating re-configuring of the schedule.

4. The method of claim 1, further comprising:
analyzing, at the server, the usage data by artificial intelligence applications hosted by the server to determine both task applicability and task changes, and to amend the pre-configured schedule by re-configuring the schedule consistent with the task applicability and task changes.

5. The method of claim 1, further comprising:
augmenting the usage data of the particular asset by machine learning applications hosted by the server.

6. The method of claim 1, further comprising:
analyzing the usage data of the asset object by an analytics engine wherein the analytics engine is coupled to the asset object for receiving the usage data.

7. The method of claim 1, further comprising:
presenting in part or in an entirety, by the server, the maintenance plan with the re-configuring of the schedule to one or more mobile devices.

8. The method of claim 1, further comprising:
accessing data from knowledge databases or multi-tenant databases to accentuate the usage data of a particular maintenance plan wherein the accessed data comprises: historic data of asset usage.

9. A computer program product tangibly embodied in a computer-readable storage device and comprising instructions configurable to be executed by a processor to perform a method for re-configuring a schedule for maintenance of an asset by use of a software product, the method comprising:
defining, at a server, an asset object for receiving usage data of the asset wherein the usage data is generated by sensing devices associated with activities of the asset;
configuring, at the server, a task relating to maintenance of the asset based on a pre-configured schedule, wherein the task is dependent on the usage data;
receiving the usage data at the server for storing in the asset object; and
analyzing, at the server, the usage data stored in the asset object for determining applicability of the task or changes in the task for re-configuring the pre-configured schedule.

10. The method of claim 9, further comprising:
analyzing, at the server, the usage data by applying a set of rules to determine whether the task of the pre-configured schedule is still applicable, or alternately has incurred a change.

11. The method of claim 9, further comprising:
amending, at the server, the pre-configured schedule if the task is deemed not applicable, or a change has incurred in the task necessitating re-configuring of the schedule.

12. The method of claim 9, further comprising:
analyzing, at the server, the usage data by artificial intelligence applications hosted by the server to determine both task applicability and task changes, and to amend the pre-configured schedule by re-configuring the schedule consistent with the task applicability and task changes.

13. The method of claim 9, further comprising:
augmenting the usage data of the particular asset by machine learning applications

14. The method of claim 9, further comprising:
analyzing the usage data of the asset object by an analytics engine wherein the analytics engine is coupled to the asset object for receiving the usage data.

15. The method of claim 9, further comprising:
presenting in part or in an entirety, by the server, the maintenance plan with both usage data and re-configuring of the schedule to one or more mobile devices.

16. A system comprising:
at least one processor; and
at least one computer-readable storage device comprising instructions configurable to be executed by the at least one processor to perform a method for re-configuring a schedule for maintenance of an asset by use of a software product, the method comprising, the method comprising:
defining, at a server, an asset object for receiving usage data of the asset wherein the usage data is generated by sensing devices associated with activities of the asset;
configuring, at the server, a task relating to maintenance of the asset based on a pre-configured schedule, wherein the task is dependent on the usage data;
receiving the usage data at the server for storing in the asset object; and
analyzing, at the server, the usage data stored in the asset object for determining applicability of the task or changes in the task for re-configuring the pre-configured schedule.

17. The system of claim 16, wherein the software product comprises a software-as-a-service (SaaS) application or a cloud application.

18. The system of claim 16, further comprising:
analyzing, at the server, the usage data by applying a set of rules to determine whether the task of the pre-configured schedule is still applicable, or alternately has incurred a change.

19. The system of claim 16, further comprising:
amending, at the server, the pre-configured schedule if the task is deemed not applicable, or a change has incurred in the task necessitating re-configuring of the schedule.

20. The system of claim 16, further comprising:
accessing data from knowledge databases or multi-tenant databases to accentuate the usage data of a particular maintenance plan wherein the accessed data comprises: historic data of asset usage; and
presenting in part or in an entirety, by the server, the maintenance plan with usage data to one or more mobile devices.
